(19) United States
(12) Patent Application Publication
(10) Pub. No.: US 2015/0242900 A1
(43) Pub. Date: Aug. 27, 2015

(54) LOCATION BASED ADVERTISING

(71) Applicant: HEWLETT-PACKARD DEVELOPMENT COMPANY, L.P., Houston, TX (US)

(72) Inventors: Murilo Juchem, Rio Grande Do Sul (BR); David Brisson, Mississauga (CA); Bernardo Huberman, Palo Alto, CA (US)

(21) Appl. No.: 14/431,218

(22) PCT Filed: Sep. 28, 2012
(86) PCT No.: PCT/US2012/058118

§ 371 Date: Mar. 25, 2015

(51) Int. Cl. G06Q 30/02

(52) U.S. Cl. CPC G06Q 30/0261; G06Q 30/0275; G06Q 30/0246

(57) ABSTRACT

Examples disclosed herein relate to generating advertisement based on a location of a client device. At least one advertisement is generated based on the location of the diem device. The at least one advertisement is selected from a plurality of advertisement bids that match a criteria related to the location of the client device. The at least one advertisement is provided to the client device while executing a printing transaction at the location.

### BACKGROUND

Location-based advertising allows advertisers to provide location-specific advertisements to consumers on their mobile devices, for example. Further, with the development of remote printing functionalities (e.g., Hewlett-Packard's ePrint), consumers are able to print documents to remote printing devices, while on the go, fern their mobile devices.

### BRIEF DESCRIPTION OF THE DRAWINGS

The present application may be more felly appreciated in connection with the following detailed description taken in conjunction with the accompanying drawings, in which like reference characters refer to like parts throughout, and in which:

FIG. 1 is a schematic diagram illustrating a location based advertising system, according to one example;

FIG. 2 is a schematic diagram illustrating a location based advertising system, according to one example;

FIG. 3 is a flowchart for implementing location based advertising, according to one example;

FIG. 4 is a flowchart for implementing location based advertising, according to one example;

FIG. 5 is a flowchart for implementing location based advertising, according to one example;

FIG. 6 is a flowchart for implementing location based advertising, according to one example; and

FIG. 7 is a block diagram of an example component for implementing the location based advertising system of FIGS. 1 and 2, according to various examples.

### DETAILED DESCRIPTION

Remote printing functionalities enable users to print documents from their mobile devices to a printing device located in a print-enabled location (e.g., a public print location or a private print location). For example, a user may locate a printing device from a list of printing devices in a particular location (e.g., a print enabled location or a print kiosk), select one or more documents to print, and send the document to the print location.

Advertisers may leverage mobile printing capabilities available to consumers by pushing advertisements (e.g., promotions, offers, coupons, etc) to print locations selected by users along with the selected, print request, thereby providing location, based advertisements to consumers. In one example, the advertisers bid on the location and a highest bid is selected from a plurality of bids matching the location. The selected advertisement (e.g., advertisement with the highest bid) is included with the print document For example, the selected advertisement may fee provided to the user electronically (i.e., on their mobile device).

To illustrate, consider the journey of a mobile consumer (i.e., on the go) who selects a document for printing from his mobile device (e.g., a smartphone). The consumer searches for a nearest public printing location to send the document for printing. The consumer finds a public printing kiosk a couple of blocks away from his current location and selects the location, uploads the document to be printed, and receives a print release code for printing the document at the printing kiosk. When the consumer gets to the printing kiosks, he enters his release code and executes a printing transaction (e.g., swipes his credit card, for payment) at the printing kiosk, and receives his document. The printed document includes a receipt for the payment made and a discount coupon for a latte at Joe's cafe, only a block away from the printing kiosk. The consumer uses the discount coupon at Joe's cafe to enjoy the discounted latte prior to his meeting.

Joe, the owner of Joe's cafe is a small business owner (i.e., an advertiser) looking for ways to further promote his business. Joe may use the described location based advertising based system to promote his business by providing discount coupons to consumers within a geographical location of his business. Thus, Joe may bid for consumers in a specific geographical radius. Accordingly, Joe creates an account, defines the message so be included in his advertisement (e.g., discounts, coupons, etc), uploads his business logo, and inserts the web address for his business. The system generates a preview of the cover page with his coupon, his logo, the promotion category (e.g., coffee shops), his message, a link to his web site, and quick response (QR) tracking code (e.g., for tracking and redeeming coupons). He approves the preview, enters his payment information, his budget for the promotion, and bids for a geographical area (e.g., New York City). Thus, Joe may bid based on country, state, city, neighborhood, zip code or global positioning system (GPS) for a geographical region. When a consumer/customer enters his business with the printed coupon, Joe may use his smartphone to scan the QR code of the coupon that is brought in, thus marking the coupon as redeemed on the system. Joe's cafe may receive an incentive (e.g., a percentage payback) on the original amount that was paid for the coupon.

Accordingly, the described examples leverage existing geo-location information to select offers/advertisements that may immediately trigger business transactions, thereby shortening the time between visualization of advertisements and redemption of such advertisements. Further, the described examples leverage unused spaces on cover pages of print jobs to deliver advertisements and promotional offers to consumers. The described examples further provide a revenue generating means by allowing advertisers bid for particular geographic locations.

In one example, a printing transaction is executed at a client device and at least one advertisement is generated based on a location of the client device. The at least one advertisement is selected from a plurality of advertisement bids that match a criteria related to tine location of the client device. The at least one advertisement is received at the client device.

In one example, a plurality of advertisement bids is received from a plurality of advertisers bidding for a location. At least one advertisement is selected for a client device based on at least one criterion that matches the location. The at least one selected advertisement is sent to the client device, where the client device is executing a printing transaction at the location.

In one example, a system includes an advertisement generating module to receive a plurality of advertisement bids from a plurality of advertisers bidding for a particular location. The system also includes an advertisement matching module to select at least one advertisement based on at least one criterion that matches the particular location, and to send the at least one selected advertisement to a client device executing a printing transaction at the location.

It is appreciated that examples described herein below may include various components and features. Some of the components and features may be removed and/or modified without departing from a scope of the method, system, and non-transitory computer readable medium for Bluetooth beacon based location determination. It is also appreciated that, in the following description, numerous specific details are set forth to provide a thorough understanding of the examples. However, it is appreciated that the examples may be practiced without limitations to these specific details. In other instances, well known methods and structures may not be described in detail to avoid unnecessarily obscuring the description of the examples. Also, the examples may be used in combination with each other.

Reference in the specification to “an example” or similar language means that a particular feature, structure, or characteristic described in connection with the example is included in at least one example, but not necessarily in other examples. The various instances of the phrase “in one example” or similar phrases in various places in the specification are not necessarily all referring to the same example. As used herein, a component is a combination of hardware and software executing on that hardware to provide a given functionality.

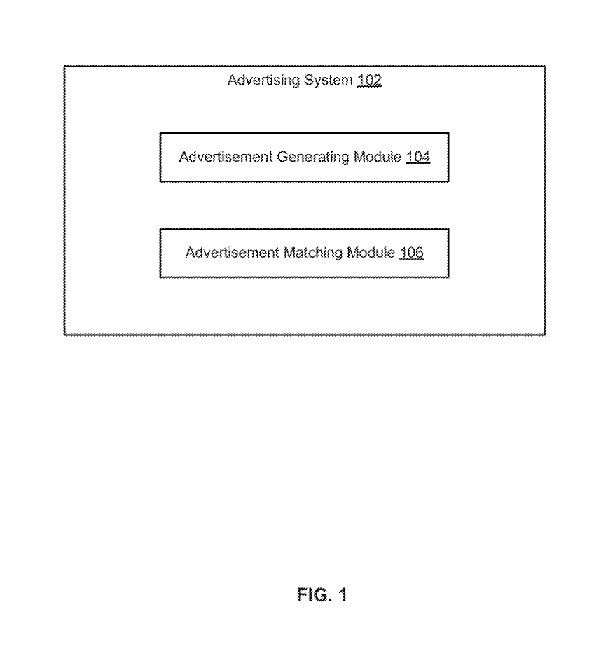

Referring now to FIG. 1, a schematic diagram illustrating a location based advertising system, according to one example, is described. Advertising system 102 includes, tor example, advertisement generating module 104 and advertisement matching module 106.

Advertisement generating module 104 may be configured to receive a plurality of advertisement bids from a plurality of advertisers bidding for a particular location. For example, advertisement generating module 104 may include a user interface (not shown) usable by advertisers for uploading promotional messages (e.g., discounts, coupons, offers, etc) and imagery (e.g., logos, etc). Further, advertisers may submit advertisement categories (e.g., food, clothing, etc) and bid amounts. For example, an advertiser may include a budget for their advertisement (e.g., dollar bid per view). Advertisers may further indicate one or more locations for which they are bidding. For example, advertisers may include a country, state, city, neighborhood, zip code, GPS coordinates, or any combination thereof. Advertisers may interact with the advertising system 102 via the advertisement generating module 104 to submit content (e.g., images and text) and preview generated advertisements prior to accepting the generated advertisements.

Advertisement matching module 106 may be configured to select at least one advertisement from the plurality of submitted advertisement based on at least one criterion that matches the particular location. For example, the advertisement matching module 106 may select a highest bid that matches the particular location from a plurality of bids for the particular location. Further, the advertisement matching module 106 may be configured to send the at least one selected advertisement to a client device executing a printing transaction at the particular location. For example, a selected highest bid for a geographical location may be sent to a mobile device (e.g., a smartphone) or a printing device at the matching location. The printing device may be located at a printing kiosk, a public printing location, or a private priming location. The printing transaction may include printing a document at the printing location. For example, the selected advertisement may be sent (e.g., printed) along with a print job executed by a user at a printing kiosk matching the location that was bid for by a “wining” advertiser. It should be noted that the selected advertisement may also be sent and received electronically at the client device (e.g., on a consumer's mobile device) at the location.

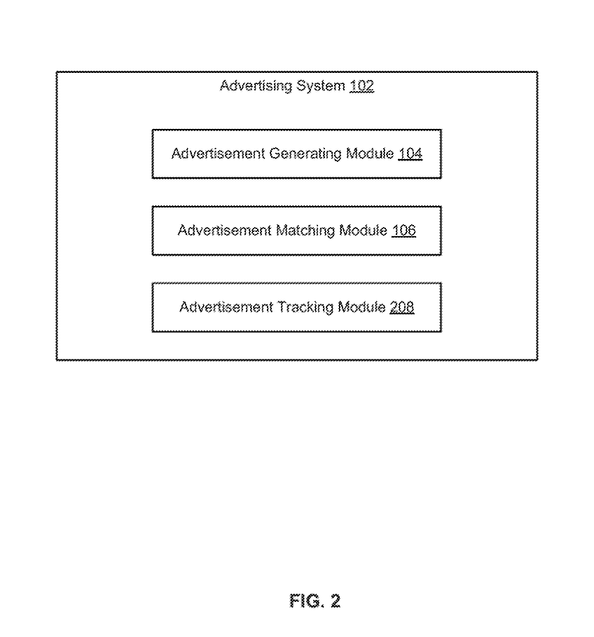

FIG. 2 is a schematic diagram illustrating a location based advertising system, according to one example. Advertising system 102 includes, for example, advertisement generating module 104, advertisement matching module 106, and advertisement tracking module 208.

As described above, advertisement generating module 104 may be configured to receive a plurality of advertisement bids from a plurality of advertisers bidding for a particular location (e.g., a geographical location or a neighborhood). The advertisements may include promotions, offers, coupons, discounts, or any combination, thereof. Advertisement matching module 106 may be configured to select at least one advertisement from the plurality of advertisement bids based on at least one criterion that matches the particular location, and send the at least one selected bid to a client device executing a printing transaction at the particular location. For example, the criterion may be the highest bid for the particular location. The selected bid may be sent to a mobile device of the user or a selected print location of the user, while the user is paying for a print job, for example.

Advertisement tracking module 208 may be configured to track the at least one advertisement to determine when, the at least one advertisement has been redeemed (by a consumer), subtract a value of the at least one advertisement from a budget associated with the at least one advertisement, and generate an incentive for an advertiser associated with the at least one advertisement. For example, advertisement tracking module 208 may track the selected advertisement via a QR code to determine when the advertisement (e.g., a discount coupon) is redeemed by a consumer. Thus, the coupon may be marked as redeemed when used at the advertiser's site (e.g., on-site or online). Accordingly, a used coupon may be subtracted from the budget of the advertisers. Further, by tracking usage of the coupon, incentives may be provided to the advertiser of the selected coupon for each coupon used by a consumer. For example, a percentage of the price paid for the advertisement, may be reimbursed to the advertiser as an incentive to track the coupon usage.

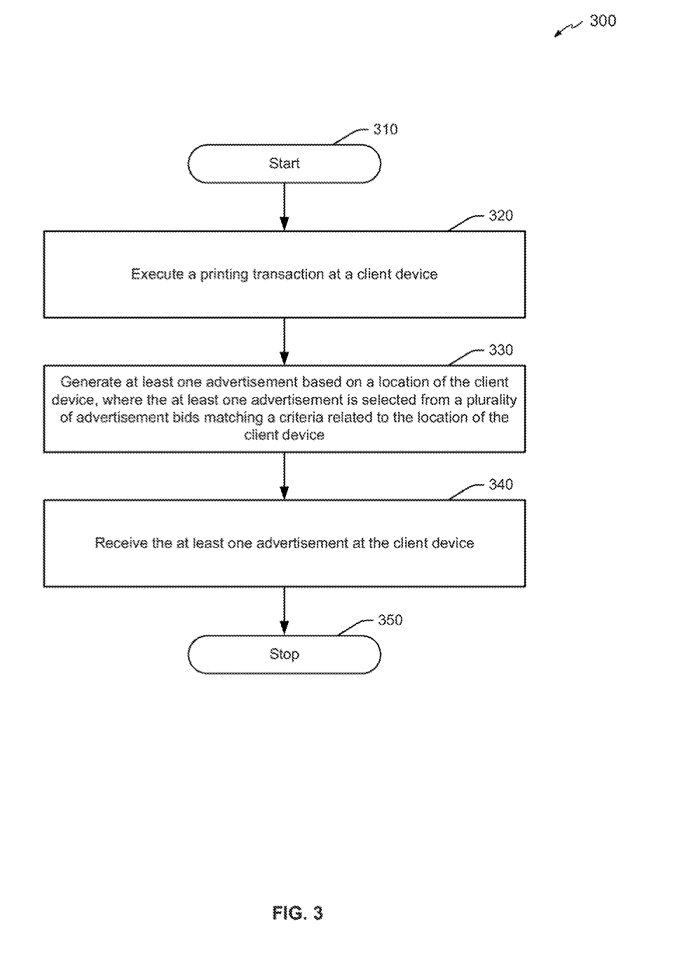

FIG. 3 is a flowchart of a method 300 tor implementing location based advertising, according to one example. Method 300 may be implemented in the form of executable instructions stored on a non-transitory machine-readable storage medium and/or in the form of electronic circuitry.

Method 300 may start in block 310 and proceed to block 320, where a printing transaction is executed at a client device. In one example, the client device includes at least one of a printing device and a mobile device. In another example, the printing transaction may include printing a document at the printing device at a print location.

Method 300 may proceed to block 330, where at least one advertisement is generated based on a location of the client device, where the at least one advertisement is selected from a plurality of advertisement bids matching a criteria related to the location of the client device. For example, a particular advertisement may be selected from a plurality of advertisements that match the location of the client device based on a highest bid for the location. The advertisement with the highest bid may be selected for the location. The advertisement may include offers, promotions, discounts, and coupons.

Method 300 may proceed to block 340, where the at least one advertisement is received at the client device. For example, the selected advertisement may be received by a consumer at a mobile device (e.g., a smartphone) as an electronic coupon, or the selected advertisement may be received by the consumer at a print location, where the selected advertisement is included in a print job of the consumer. Method 300 may then proceed to block 350, where the method 300 stops.

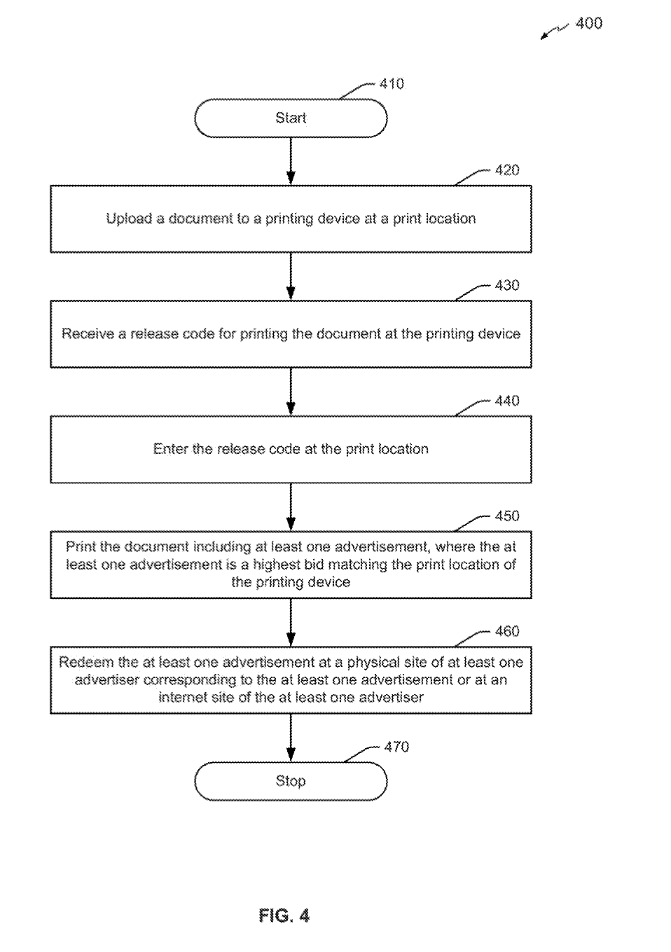

FIG. 4 is a flowchart of a method 400 for implementing location based advertising, according to one example. Method 400 may be implemented in the form of executable instructions stored on a non-transitory machine-readable storage medium and/or in the form of electronic circuitry.

Method 400 may start in block 410 and proceed to block 420, where a document is uploaded to a printing device at a printing location. For example, a consumer may select a document to print, and select a printing device at a particular print location from a plurality of available print locations. The print location may be at least one of a private print location and a public print location (e.g., a printing kiosk).

Method 400 may proceed to block 430, where a release code for printing the document is received at the printing device. For example, when the consumer uploads the document to the printing device at the print location, the consumer may receive the release code to be used at the print location.

Method 400 may proceed to block 440, where the release code is entered at the print location. For example, the consumer may enter the release code at the print location, where the release code may be as authorization code to permit the consumer to print or to receive a printout of the document at the print location.

Method 400 may proceed to block 450, where the document including at least one advertisement is printed. In one example, the at least one advertisement represents a highest bid that matches the print location of the printing device. For example, the printing device may output the document including at least one advertisement selected from a plurality of advertisement matching the print location. To illustrate, the document may include a coupon for a store/shop in close proximity to the print location where the consumer may use the coupon to receive a discount from the store/shop. In one example, the selected coupon may be a highest bid for the print location from a plurality of advertisers bidding for the print location.

Method 400 may proceed to block 460, where the at least one advertisement is redeemed at a physical site of at least one advertiser corresponding to the at least one advertisement or at an internet site of the at least one advertiser. For example, the consumer may redeem the coupon at an online site or on-site location of the advertiser. Method 400 may then proceed to block 470, where the method 400 stops.

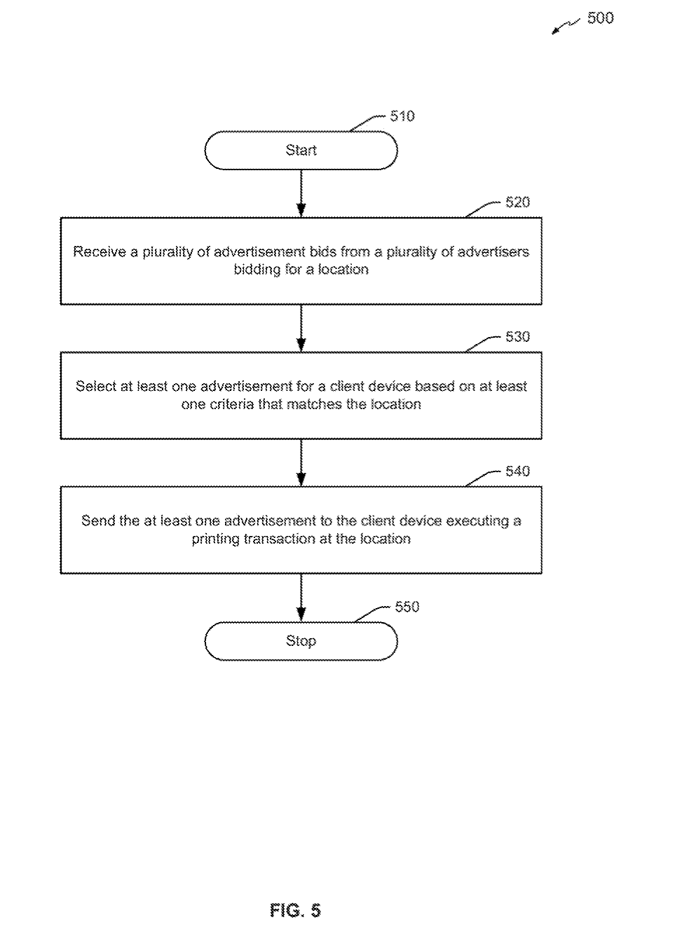

FIG. 5 is a flowchart of a method 500 for implementing location based advertising, according to one example. Method 500 may be implemented in the form of executable instructions stored on a non-transitory machine-readable storage medium and/or in the form of electronic circuitry.

Method 500 may start in block 510 and proceed to block 520, where a plurality of advertisement bids is received from a plurality of advertisers bidding for a location. For example, advertisers may bid for a particular location via an interface of the advertising system 102. The location may be indicated by city, state, zip code, GPS coordinates, neighborhood, or any combination thereof.

Method 500 may proceed to block 530, where at least one advertisement is selected tor a client device based on at least one criterion that matches the location. For example, an advertisement (e.g., an offer, coupon, discount, or promotion) may be selected that is a highest bid for the location.

Method 500 may proceed to block 540, where the at least one advertisement is sent to the client device executing a printing transaction at the location. For example, the advertisement having the highest bid for the location may be sent to a mobile device or a print location. Method 500 may then proceed to block 550, where the method 500 stops.

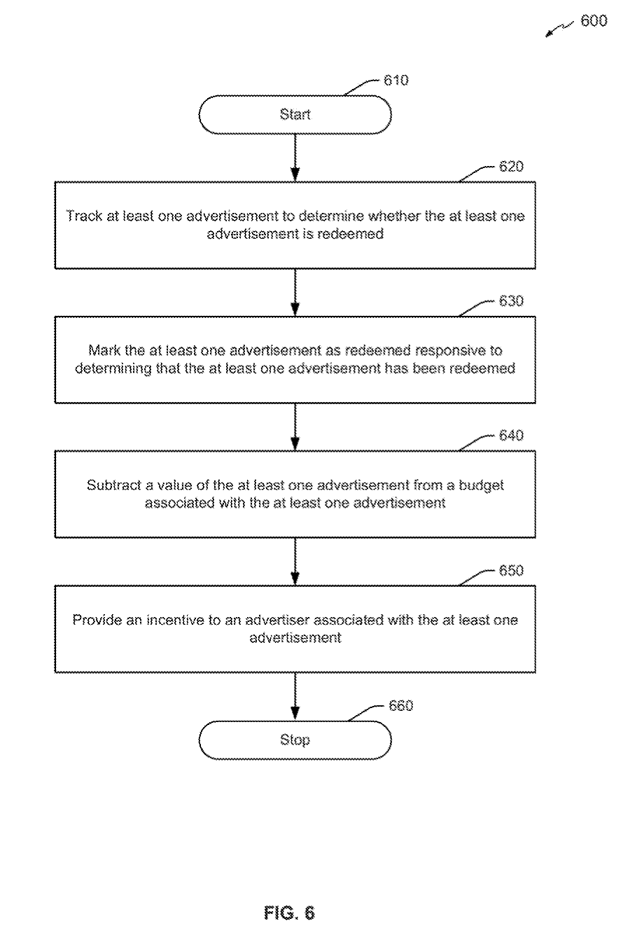

FIG. 6 is a flowchart of a method 600 for implementing location based advertising, according to one example. Method 600 may be implemented in the form of executable instructions stored on a non-transitory machine-readable storage medium and/or in the form of electronic circuitry.

Method 600 may start in block 610 and proceed to block 620, where at least one advertisement is tracked to determine whether the at least one advertisement is redeemed. For example, a discount coupon may be tracked via QR code embedded on the discount coupon to determine when the advertisement is redeemed.

Method 600 may proceed to block 630, where the at least one advertisement is marked as redeemed responsive to determining that the at least one advertisement has been redeemed. For example, the advertising system 102 may indicate that the coupon has been redeemed when the QR code on the discount coupon has been scanned (i.e., used).

Method 600 may proceed to block 640, where a value of the at least one advertisement is subtracted from a budget associated with at least one advertisement. For example, a used coupon may be subtracted from the budget of the advertiser.

Method 600 may proceed to block 650, where an incentive is provided to an advertiser associated with the at least one advertisement. For example, by tracking usage of the coupon, incentives may be provided to the advertiser associated with the coupon. In one example, a percentage of the price paid for the advertisement (by the advertiser) may be provided to the advertiser (e.g., 10%). Method 600 may then proceed to block 660, where the method 600 stops.

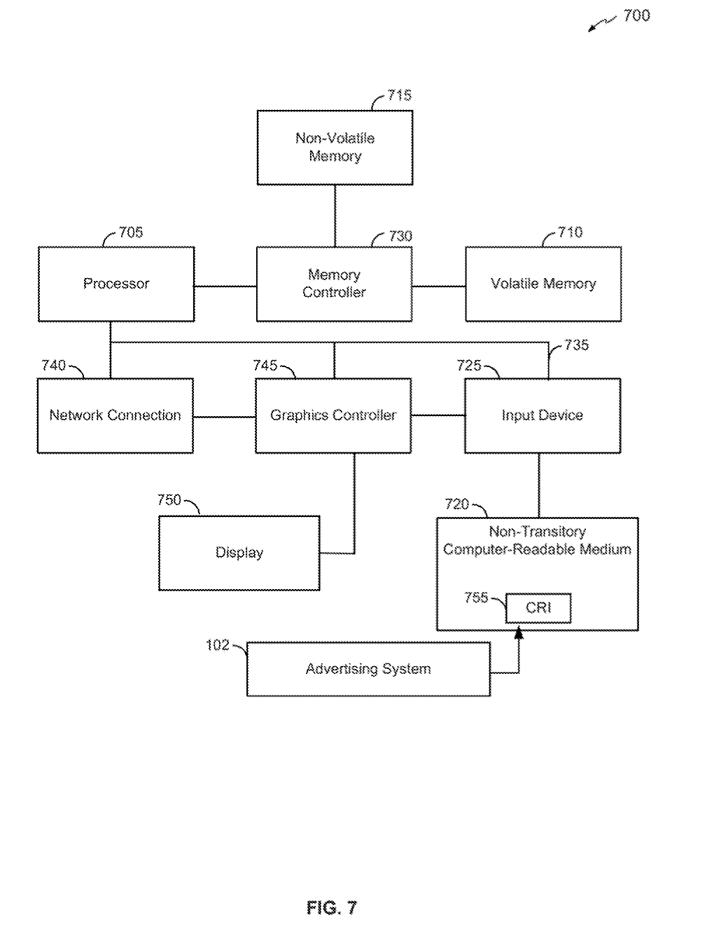

The advertising system 102 of FIGS. 1 and 2 can be implemented in hardware, software, or a combination of both. FIG. 7 illustrates a component for implementing the advertising system 102 according to various examples. The component 700 can include a processor 705 and memory resources, such as, for example, the volatile memory 710 and/or the non-volatile memory 715, for executing instructions stored in a tangible non-transitory medium (e.g., volatile memory 710, non-volatile memory 715, and/or computer readable medium 720). The non-transitory computer-readable medium 720 can have computer-readable instructions 755 stored thereon that are executed by the processor 705 to implement a network controller that utilizes client mobile devices for wireless network monitoring according the present disclosure.

A machine (e.g., a computing device) can include and/or receive a tangible non-transitory computer-readable medium 720 storing a set of computer-readable instructions (e.g., software) via an input device 725. As used herein, the processor 705 can include one or a plurality of processors such as in a parallel processing system. The memory can include memory addressable by the processor 705 for execution of computer readable instructions. The computer readable medium 720 can include volatile and/or non-volatile memory such as a random access memory (“RAM”), magnetic memory such as hard disk, floppy disk, and/or tape memory, a solid state drive (“SSD”), flash memory, phase change memory, and so on. In some examples, the non-volatile memory 715 can be a local or remote database including a plurality of physical non-volatile memory devices.

The processor 705 can control the overall operation, of the component 700. The processor can be connected to a memory controller 730, which can read and/or write data from and/or to volatile memory 710 (e.g., RAM). The processor 705 can be connected to a bus 735 to provide communication between the processor 705, the network connection 740, and other portions of the component 700. The non-volatile memory 715 can provide persistent dates storage for the component 700. Further, the graphics controller 745 can connect to an optical display 750.

Each component 700 can include a computing device including control circuitry such as a processor, a state machine, ASIC, controller, and/or similar machine. As used herein, the indefinite articles “a” and/or “an” can indicate one or more of the named objects. Thus, for example, “a processor” can include one or more than one processor, such as in a multi-core processor, cluster, or parallel processing arrangement.

It is appreciated that the previous description of the disclosed examples is provided to enable any person skilled in the art to make or use the present disclosure. Various modifications to these examples will be readily apparent to those skilled in the art, and the generic principles defined herein may be applied to other examples without departing from the spirit or scope of the disclosure. Thus, the present disclosure is not intended to be limited to the examples shown herein but is to be accorded the widest scope consistent with the principles and novel features disclosed herein. For example, it is appreciate that the present disclosure is not limited to a particular configuration, such as component 700.

Those skilled in the art would further appreciate that the various illustrative modules and steps described in connection with the examples disclosed herein may be implemented as electronic hardware, computer software, or combination of both. For example, the steps of FIGS. 3-6 may be implemented using software modules, hardware modules or components, or a combination of software and hardware modules or components. Thus, in one example, one or more of the example steps of FIGS. 3-6 may comprise hardware modules or components. In another example, one or more of the steps of FIGS. 3-6 may comprise software code stored on a computer readable storage medium, which is executable by a processor.

To clearly illustrate this interchangeability of hardware and software, various illustrative components, blocks, modules, and steps have been described above generally in terms of their functionality. Whether such functionality is implemented as hardware or software depends upon the particular application and design constraints imposed on the overall system. Those skilled in the art may implement the described functionality in varying ways for each particular application, but such implementation decisions should not be interpreted as causing a departure from the scope of the present disclosure.

What is claimed is:

1. A method comprising:
executing a printing transaction at a client device; and
generating at least one advertisement based on a location of the client device, wherein the at least one advertisement is selected from a plurality of advertisement bids matching a criteria related to the location of the client device; and
receiving the at least one advertisement at the client device.

2. The method of claim 1, wherein the client device includes at least one of a printing device and a mobile device.

3. The method of claim 1, wherein the at least one advertisement includes at least one of a discount coupon and a promotional offer for goods and services.

4. The method of claim 1, wherein the criteria includes a highest bid of a plurality of advertisement bids that match the location of the client device.

5. The method of claim 1, wherein the printing transaction includes printing a document at a printing device.

6. The method of claim 5, comprising:
uploading the document to the printing device at a print location;
receiving a release code for printing the document at the printing device;
entering the release code at the print location; and
printing the document including the at least one advertisement, wherein the at least one advertisement is a highest bid matching the print location of the printing device.

7. The method of claim 6, wherein the print location includes at least one of country, state, city, neighborhood, zip code, and global positioning system (GPS) coordinates.

8. The method of claim 6, wherein the print location includes at least one of a public printing facility and a private printing facility.

9. The method of claim 1, comprising redeeming the at least one advertisement, wherein the at least one advertisement is redeemed at a physical site of at least one advertiser corresponding to the at least one advertisement or at an internet site of the at least one advertiser.

10. A method comprising:
receiving a plurality of advertisement bids from a plurality of advertisers bidding for a location;
selecting at least one advertisement for a client device based on at least one criterion that matches the location;
sending the at least one advertisement to the client device executing a printing transaction at the location.

11. The method of claim 10, comprising:
tracking the at least one advertisement to determine whether the at least one advertisement is redeemed;
marking the at least one advertisement as redeemed responsive to determining that the at least one advertisement has been redeemed;
subtracting a value of the at least one advertisement from a budget associated with the at least one advertisement;
providing an incentive to an advertiser associated with the at least one advertisement.

12. The method of claim 11, wherein the incentive includes a percentage of the value of the at least one advertisement.

13. A system comprising:
an advertisement generating module to receive a plurality of advertisement bids from a plurality of advertisers bidding for a particular location; and
an advertisement matching module to:
select at least one advertisement based on at least one criterion that matches the particular location; and
send the at least one advertisement to a client device executing a printing transaction at the particular location.

14. The system of claim 13, comprising an advertisement tracking module to:
track the at least one advertisement;
mark the at least one advertisement as redeemed in response to determining that the at least one advertisement is redeemed;
subtract a value of the at least one advertisement from a budget related to the at least one advertisement; and
generate an incentive for an advertiser associated with the at least one advertisement

15. The system of claim 13, the advertising generating module to generate the at least one advertisement comprising at least one of a coupon, advertising messages, website address, uniform resource locator (URL), advertiser's logo, and a quick response (QR) code for tracking the at least one advertisement.
